(19) United States
(12) Patent Application Publication
(10) Pub. No.: US 2016/0185075 A1
(43) Pub. Date: Jun. 30, 2016

(54) Composite Fibre Panel

(71) Applicant: KNAUF INSULATION, Vise (BE)

(72) Inventors: Gorazd Sebenik, Mont-Saint-Guibert (BE); Jure Sumi, Mont-Saint-Guibert (BE); Miha Kese, Mont-Saint-Guibert (BE); Tomaz Luznik, Mont-Saint-Guibert (BE)

(21) Appl. No.: 14/954,268

(22) Filed: Nov. 30, 2015

Related U.S. Application Data
(63) Continuation of application No. 14/375,957, filed on Jul. 31, 2014, now abandoned.

(30) Foreign Application Priority Data
Feb. 3, 2012 (GB) GB 1201885.9

(51) Int. Cl. B32B 5/18; E06B 5/20; B29C 65/00; B32B 15/04; B32B 21/04; E06B 5/16; E04F 15/10

(52) U.S. Cl. CPC B32B 5/18; E06B 5/16; E06B 5/20; E04F 15/102; B32B 15/046; B32B 21/047; B29C 65/00; B32B 2262/10; B32B 2266/0278; B32B 2307/3065; B32B 2307/102; B32B 2419/00; B32B 2419/04; B29K 2007/00

(57) ABSTRACT

A composite fibre panel comprising: between 20% and 70% by weight mineral fibres; and between 30% and 80% polymeric material; and in which the polymeric material comprising polymeric material in particulate form may be used to provide improved acoustic and/or fire performances.

### CROSS-REFERENCE TO RELATED APPLICATIONS

This application is a continuation of U.S. application Ser. No. 14/375,957, filed Jul. 31, 2014, which is a U.S. national counterpart application of International Application Serial No. PCT/EP2013/052103, filed Feb. 1, 2013 under 35 U.S.C. §371, which claims priority to GB Application Serial No. 1201885.9, filed Feb. 3, 2012, the entire disclosures of each of which are hereby incorporated by reference herein.

### TECHNICAL FIELD

This invention relates to a composite fibre panel, in particular an acoustic panel, especially for use in door constructions, floor insulation or sandwich panels.

### BACKGROUND

One known form of panel used in doors comprises a mixture of coconut fibres, polyurethane (PU) foam, particulate rubber and glue. The heterogeneous nature of these panels contributes to their good sound absorbing properties and the availability of their constituent parts allows their manufacture at moderate cost.

U.S. Pat. No. 4,256,803A discloses a panel having an expanded phenolic resin core incorporating fillers and a polycondensed phenolic resin layer outer covering layer which is reinforced with glass fibre fabric.

JP2009052033 discloses a thermoplastic resin composition for expansion moulding which incorporates wood flour and a filler.

The panels disclosed in U.S. Pat. No. 4,256,803A and JP2009052033 are not adapted to provide advantageous sound absorbing properties, nor to be used in the specific applications envisaged for the present invention.

One aim of the present invention is to provide panels which can match the acoustic performance and cost of known panels but also provide additional advantages.

### SUMMARY

According to one aspect, the present invention provides a composite fibre panel as defined in claim 1. Other aspects are defined in other dependent claims whilst the dependent claims define preferred and/or alternative embodiments.

### DETAILED DESCRIPTION

The use of mineral fibres, for example stone wool fibres or glass wool fibres, in the quantities specified may be used to confer advantageous fire resistance and/or good levels of compressive strength and/or low thermal conductivity upon the panels. Each of these properties, either individually or combined, is particularly useful when the composite panels are used in doors or sandwich panels.

The combination of different materials in the composite fibre panels contributes to their ability to absorb sound and thus to their acoustic performance. A foam material included as part of the polymeric material serves such a purpose as does a polymeric material in particulate form and as does the combination of these materials. The foam may have a closed cell structure or an open cell structure or a combination thereof; it may comprise polyurethane foam, expanded polystyrene foam (EPS), extruded polustyrene foam (XPS) or mixtures thereof. The polymeric material in particulate form may be in the form of particles, preferably particles of different sizes, and may be provided as scraps or recycled material; the polymeric material in particulate form may comprise rubber(s), natural rubber(s), synthetic rubber(s), polyurethane, elastomer(s) or mixtures thereof. The mean geometric diameter of the polymeric material in particulate form may be ≧0.1 mm or ≧0.2 mm or ≧0.5 mm or ≧1 mm or ≧2 mm. The mean geometric diameter of the polymeric material in particulate form may be ≦30 mm or ≦20 mm or ≦10 mm or ≦5 mm.

The provision of a composite fibre panel having a height of at least 160 cm and a width of at least 60 cm allows the panel to be used without requiring additional panels to fill the cavity of a fire rated door. Handling and assembling a single panel is easier and more efficient than dealing with multiple different panels. In addition, the provision of a single or unitary panel having dimensions that can fill the entire cavity of a door avoids the risk of a point of weakness or a thermal bridge in the insulation that would occur at the abutments of separate but adjoining panels. The panel may be substantially rectangular; it may be provided with preformed cuts and/or cut-outs to facilitate its assembly in a door cavity. The panel may be provided as a single or as a multilayer arrangement, for example of two or more superposed panels.

The dimensions of the composite fibre panel may be:
height ≧160 cm, optionally ≧180 cm or ≧200 cm and/or ≦300 cm, optionally ≦260 cm or ≦230 cm;
width ≧60 cm, optionally ≧70 cm or ≧80 cm and/or ≦200 cm, optionally ≦140 cm or ≦100 cm;
thickness preferably ≧1 cm, optionally ≧1.5 cm or ≧2 cm and/or preferably ≦12 cm, optionally ≦10 cm or ≦8 cm

The composite fibre panel is particularly suited for use in doors, particularly in fire rated doors and even more particularly in doors meeting a Ei 30, Ei45 or Ei 60, fire class. The doors may be functional doors. In one embodiment, the doors comprise peripheral wooden skins or wooden external panels or cover plates which define an internal door cavity in which the composite fibre panel is arranged. Each wooden cover plate may have a thickness ≧2 mm, notably ≧2.5 mm or ≧3 mm and/or ≦8 mm notably ≦5 mm or ≦4.5 mm. The cover plates may be of chipboard or medium density fibre board (MDF) and may comprise a veneer.

In an alternative embodiment the doors comprise peripheral sheet metal skins or sheet metal external panes, notably of steel, which define an internal door cavity in which the composite fibre panel is arranged.

The doors may have a door leaf thickness ≧30 mm, notably ≧35 mm or ≧40 mm and/or ≦100 mm notably ≦75 mm or ≦50 mm. The door leaf weight in kg/m² may be thickness ≧10, notably ≧15 or ≧20 and/or ≦100 notably ≦70 or ≦40.

The density of the composite fibre panels may be:
at least 300 kg/m³; notably at least 400 kg/m³ or at least 500 kg/m³; and/or
not more than 800 kg/m³, notably not more than 700 kg/m³ or 600 kg/m³.

The polymeric material in the form of a foam may have a density ≦60 kg/m³, ≦50 kg/m³, or notably ≦40 kg/m³; it may have a density ≧5 kg/m³, ≧10 kg/m³ or notably ≧20 kg/m³. Foams having such densities may be referred to as “light foams”. The composite fibre panels may comprise a hard foam, for example a foam having a density ≧60 kg/m³, ≧80 kg/m³ or notably ≧100 kg/m³ and/or ≦160 kg/m³, or notably ≦150 kg/m³.

Such densities may contribute to the compressive strength and/or fire performance and thus facilitate use in doors, floor applications and/or sandwich panels for structural applications.

The compressive strength of the composite fibre panels may be at least 300 kPA, notably at least 350 kPA, at least 400 kPA, at least 450 kPA or at least 500 kPA when tested according EN 826. Such compressive strength facilitates use in doors and/or sandwich panels for structural applications.

The thickness of the composite fibre panels may be at least 15 mm, notably at least 20 mm, at least 25 mm, at least 30 mm, at least 40 mm or at least 50 mm; it may be no more than 250 mm, notably no more than 200 mm. Such thicknesses are suitable for use in doors and/or sandwich panels for structural applications.

The thermal conductivity of the composite fibre panels may be less than 0.130 W/mK, notably less than 0.110 W/mK, less than 0.105 W/mK, less than 0.100 W/mK, preferably less than 0.095 W/mK.

The composite fibre panels may also comprise one or more additives for example: small stones (dolomites, quartz sand), paper. Such additives may be derived from recycled materials and/or provided in particulate form, notably having a mean geometric diameter ≧0.1 mm or ≧0.2 mm or ≧0.5 mm or ≧1 mm or ≧2 mm and/or ≦10 mm or ≦5 mm.

The presence of the polymeric material preferably reduces sound transmission in the range from 50 to 5000 Hz. The characteristic(s) (notably diameter, length, density, composition, quantity) of the polymeric material in particulate form, of the polymeric material in the form of the foam of the mineral fibres or of the additives and the characteristic of the composite fibre panel (thickness) may be used to control the sound transmission of the composite fibre panel. Any combination of these different characteristics may be used to control the amplitude and/or and frequency of sound transmitted through the panel.

The invention also relates to doors and panels which comprise composite fibre panels according to the invention.

Such doors and panels may have:
a sound insulation category of at least SSK3, preferably SSK2, more preferably SSK1; and/or
a sound isolation on the facility RW,R (DIN 4109) of at least 35-39 dB, preferably 30-34 dB, more preferably 25-29 dB; and/or
a laboratory sound isolation RW (EN ISO 140-3) of at least minimum 42 dB, preferably minimum 37 dB, more preferably minimum 32 dB;
   particularly for doors or panels comprising the construction:
   wooden facing 2-6 mm thick (notably about 3-4.5 mm thick)/composite fibre panel 15-60 mm thick (notably about 25-50 mm thick, particularly 30-45 mm thick)/wooden facing 2-6 mm thick (notably about 3-4.5 mm thick).

Embodiments of the invention will now be described, by way of example only.

Composite fibre boards were produced having the following compositions:

| | Examples | | |
|---|---|---|---|
| | Comparative | Examples | Examples |
| Material (% weight) | examples | 1a and 1b | 2a and 2b |
| Coconut fibres | 50% | 0% | 0% |
| Stone wool mineral fibres | 0% | 32% | 52% |
| Polymeric material being | 50% | 68% | 48% |
| i) PU foam | 15% | 22% | 10% |
| ii) Rubber in particular form | 25% | 38% | 26% |
| iii) binder (glue) | 10% | 8% | 12% |

and the following properties:

| | | Examples | | | | | |
|---|---|---|---|---|---|---|---|
| | | Comparative | | | | | |
| | | examples | | Examples 1a and 1b | | Examples 2a and 2b | |
| | | Ca | Cb | 1a | 1b | 2a | 2b |
| | | (single | (double | (single | (double | (single | (double |
| parameter | unit | layer) | layer) | layer) | layer) | layer) | layer) |
| thickness | mm | 20 | 36.8 | 23.8 | 43.2 | 23.7 | 43.1 |
| density | kg/m3 | 525 | 585 | 492 | 526 | 452 | 495 |
| Thermal | W/mK | 0.1175 | 0.1146 | 0.0973 | 0.0943 | 0.0902 | 0.0879 |
| conductivity | | | | | | | |
| λ | | | | | | | |

| | | | | |
|---|---|---|---|---|
| Compressive | kPa | 340 | 688 | 520 |
| Strength | | | | |
| (average) | | | | |

The boards were produced by thoroughly mixing the materials together and allowing the binder to cure. Due to the thorough mixing, the mineral fibres and the polymeric material are present through the core of the board, and preferably through the entire thickness of the board.

Two sandwich panels were produced, each having a thin steel sheet 1.0 mm thick adhered to each major surface of a fibre board in accordance with example 2a. When assembled, these sandwich panels had a core thickness of 20 mm. When subjected to a fire resistance test according to EN 1363-1 these panels achieved a fire rating of 37 minutes. By comparison, a similar sandwich panel constructed with a core according to Comparative example Cb started burning after 15 minutes when subjected to this test.

1.-15. (canceled)

16. A fire door having a fire class of at least Ei30 comprising a composite fibre panel having a core comprising:
between 20% and 70% by weight of mineral fibres; and
between 30% and 80% by weight of polymeric material;
and in which the polymeric material comprises (i) polymeric material in particulate form selected from the group consisting of rubber(s), natural rubber(s), synthetic rubber(s), polyurethane, elastomer(s) and mixtures thereof and (ii) polymeric material in the form of a foam.

17. The fire door of claim 16, in which the composite fibre panel comprises between 10% and 30% by weight of polyurethane foam.

18. The fire door of claim 16, in which the composite fibre panel comprises between 10% and 30% by weight of polymeric material in particulate form.

19. The fire door of claim 16, in which the composite fibre panel has a density which is at least 300 kg/m³ and a density which is less than 800 kg/m³.

20. The fire door of claim 16, in which the composite fibre panel has a thickness selected from a thickness of at least 10 mm, a thickness of at least 15 mm and a thickness of at least 20 mm.

21. The fire door of claim 16, in which the mineral wool fibres are stone wool fibres having an average diameter in the range of 2-10 μm and an average length in the range 2-30 mm.

22. The fire door of claim 16, in which the composite fibre panel has a compression strength of at least 300 kPa.

23. The fire door of claim 16, in which the composite fibre panel has a thermal conductivity of not more than 0.130 W/mK.

24. The fire door of claim 16, in which the composite fibre panel has a sheet material secured to each of its major surfaces, the sheet material being selected from wooden plates and metal plates.

25. The fire door of claim 16, in which the composite fibre panel is selected from:
a composite fibre panel having a sound insulation category of at least SSK3;
a composite fibre panel having a sound isolation RW,R (DIN 4109) of at least 35-39 dB; and
a composite fibre panel having a laboratory sound isolation RW (EN ISO 140-3) of at least minimum 42 dB.

26. A sandwich panel for structural applications comprising a composite fibre panel having a sheet material secured to each of its major surfaces, the sheet material being selected from wooden plates and metal plates, the composite fibre panel having a core comprising:
between 20% and 70% by weight of mineral fibres; and
between 30% and 80% by weight of polymeric material;
and in which the polymeric material comprises (i) polymeric material in particulate form selected from the group consisting of rubber(s), natural rubber(s), synthetic rubber(s), polyurethane, elastomer(s) and mixtures thereof and (ii) polymeric material in the form of a foam.

27. The sandwich panel of claim 26, in which the composite fibre panel comprises between 10% and 30% by weight of polyurethane foam.

28. The sandwich panel of claim 26, in which the composite fibre panel comprises between 10% and 30% by weight of polymeric material in particulate form.

29. The sandwich panel of claim 26, in which the composite fibre panel has a density which is at least 300 kg/m³ and a density which is less than 800 kg/m³.

30. The sandwich panel of claim 26, in which the composite fibre panel has a thickness selected from: a thickness of at least 10 mm, a thickness of at least 15 mm and a thickness of at least 20 mm.

31. The sandwich panel of claim 26, in which the mineral wool fibres are stone wool fibres having an average diameter in the range of 2-10 μm and an average length in the range 2-30 mm.

32. The sandwich panel of claim 26, in which the composite fibre panel has a compression strength of at least 300 kPa.

33. The sandwich panel of claim 26, in which the composite fibre panel has a fire class of at least Ei30.

34. The sandwich panel of claim 26, in which the composite fibre panel has a thermal conductivity of not more than 0.130 W/mK.

35. The sandwich panel of claim 26, in which the composite fibre panel is selected from:
a composite fibre panel having a sound insulation category of at least SSK3;
a composite fibre panel having a sound isolation RW,R (DIN 4109) of at least 35-39 dB; and
a composite fibre panel having a laboratory sound isolation RW (EN ISO 140-3) of at least minimum 42 dB.

36. A floor comprising a composite fibre panel having a density of at least 300 kg/m³ and having a core comprising:
between 20% and 70% by weight of mineral fibres; and
between 30% and 80% by weight of polymeric material;
and in which the polymeric material comprises (i) polymeric material in particulate form selected from the group consisting of rubber(s), natural rubber(s), synthetic rubber(s), polyurethane, elastomer(s) and mixtures thereof and (ii) polymeric material in the form of a foam.

37. The floor of claim 36, in which the composite fibre panel comprises between 10% and 30% by weight of polyurethane foam.

38. The floor of claim 36, in which the panel comprises between 10% and 30% by weight of polymeric material in particulate form.

39. The floor of claim 36, in which the panel has a density of less than 800 kg/m³.

40. The floor of claim 36, in which the composite fibre panel has a thickness selected from a thickness of at least 10 mm, a thickness of at least 15 mm and a thickness of at least 20 mm.

41. The floor of claim 36, in which the mineral wool fibres are stone wool fibres having an average diameter in the range of 2-10 μm and an average length in the range 2-30 mm.

42. The floor of claim 36, in which the composite fibre panel has a compression strength of at least 300 kPa.

43. The floor of claim 36, in which the composite fibre panel has a thermal conductivity of not more than 0.130 W/mK.

44. The floor of claim 36, in which the composite fibre panel has a sheet material secured to each of its major surfaces, the sheet material being selected from wooden plates and metal plates.

45. The floor of claim 44, in which the composite fibre panel has a fire class of at least Ei30.

46. The floor of claim 36, in which the composite fibre panel is selected from:
a composite fibre panel having a sound insulation category of at least SSK3;
a composite fibre panel having a sound isolation RW,R (DIN 4109) of at least 35-39 dB; and
a composite fibre panel having a laboratory sound isolation RW (EN ISO 140-3) of at least minimum 42 dB.

47. A method for manufacturing a composite fibre panel having a density of at least 300 kg/m³ and comprising thoroughly mixing:
a) between 20% and 70% by weight of mineral fibres; and
b) between 30% and 80% by weight of polymeric material in which the polymeric material comprises polymeric material in particulate form and polymeric material in the form of a foam; and
c) a binder;
and allowing the binder to cure.

48. The method of claim 47, in which the polymeric material in particulate form is selected from the group consisting of rubber(s), natural rubber(s), synthetic rubber(s), polyurethane, elastomer(s) and mixtures thereof.

49. A method for manufacturing a composite fibre panel for the fire door of claim 16 comprising thoroughly mixing:
a) between 20% and 70% by weight of mineral fibres; and
b) between 30% and 80% by weight of polymeric material in which the polymeric material comprises polymeric material in particulate form selected from the group consisting of rubber(s), natural rubber(s), synthetic rubber(s), polyurethane, elastomer(s) and mixtures thereof and polymeric material in the form of a foam; and
c) a binder;
and allowing the binder to cure.

50. A method for manufacturing the sandwich panel of claim 26 comprising thoroughly mixing:
a) between 20% and 70% by weight of mineral fibres; and
b) between 30% and 80% by weight of polymeric material in which the polymeric material comprises polymeric material in particulate form selected from the group consisting of rubber(s), natural rubber(s), synthetic rubber(s), polyurethane, elastomer(s) and mixtures thereof and polymeric material in the form of a foam; and
c) a binder;
allowing the binder to cure and securing a sheet plate selected from wooden plate and metal plate on each of the major surfaces of the composite fibre panel

51. A method for manufacturing the composite fibre panel for the floor of claim 36 comprising thoroughly mixing:
a) between 20% and 70% by weight of mineral fibres; and
b) between 30% and 80% by weight of polymeric material in which the polymeric material comprises polymeric material in particulate form selected from the group consisting of rubber(s), natural rubber(s), synthetic rubber(s), polyurethane, elastomer(s) and mixtures thereof and polymeric material in the form of a foam; and
c) a binder;
and allowing the binder to cure.
